(19) United States
(12) Patent Application Publication
(10) Pub. No.: US 2018/0370721 A1
(43) Pub. Date: Dec. 27, 2018

(54) MANUAL BIN COMPACTING PLATE

(71) Applicant: Innovative Safety Management Solutions Pty Ltd, Glen Waverley Victoria (AU)

(72) Inventor: Emma Dickson, Bacchus Marsh, Victoria (AU)

(21) Appl. No.: 15/781,980

(22) PCT Filed: Dec. 7, 2016
(86) PCT No.: PCT/AU2016/051198

§ 371 Date: Jun. 6, 2018

(30) Foreign Application Priority Data
Dec. 7, 2015 (AU) 2015905068

(51) Int. Cl. B65F 1/14

(52) U.S. Cl. CPC B65F 1/1405; B30B 15/062

(57) ABSTRACT

The present invention relates to a manual bin compacting plate for use in compacting rubbish.

### FIELD OF THE INVENTION

The present invention relates to a manual bin compacting plate.

### BACKGROUND OF THE INVENTION

Statistics show that manual handling of wheelie bin rubbish is responsible for a large number of hand related injuries. Research has also shown that almost two thirds of those surveyed have experienced cuts, infections or other hand related injury when manually handling wheelie bin rubbish.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

In a first aspect the present invention provides a bin compacting plate comprising a compacting body sized to fit within a bin.

Preferably, the body is generally rigid and flat, and having a bottom surface and a top surface.

Preferably, the body comprises a perimeter flange extending generally upwardly from a perimeter edge of the body.

Preferably, the top surface comprises at least one handle.

Preferably, the top surface comprises left and right hand print outlines.

Preferably, the hand print outlines comprise the writing “PUSH DOWN HERE”.

Preferably, the compacting plate is made from rigid metal or plastics material.

Alternatively, the compacting plate comprises two side by side handles.

Preferably, the compacting plate includes a resilient sealing strip extending around the perimeter thereof.

Alternatively, the compacting plate includes a resilient flange extending outwardly from a perimeter edge thereof.

Preferably, the compacting plate includes an attachment means to hang the compacting plate to a handle of a bin when not in use.

Alternatively, the compacting plate includes one or more elastic straps to attach the compacting plate to the lid of a bin.

Preferably, the compacting plate includes means for connection to a larger expander plate body to increase the width and length of the compacting plate.

Preferably, the compacting plate further comprises an expander plate body for attachment thereto.

Alternatively the compacting plate comprises a curved bottom surface.

Preferably, the bottom surface is bowl shaped or inverted bowl shaped.

Other aspects of the invention are also disclosed herein.

### BRIEF DESCRIPTION OF THE DRAWINGS

Notwithstanding any other forms which may fall within the scope of the present invention, preferred embodiments of the present invention will now be described, by way of examples only, with reference to the accompanying drawings in which:

FIG. 1 is a perspective view of a manual bin compacting plate in accordance with a preferred embodiment of the present invention;

FIG. 2 is a top view of the compacting plate of FIG. 1; and

FIG. 3 is (a) a side view and (b) a bottom view of the compacting plate of FIG. 1.

### DESCRIPTION OF EMBODIMENTS

It should be noted in the following description that like or the same reference numerals in different embodiments denote the same or similar features.

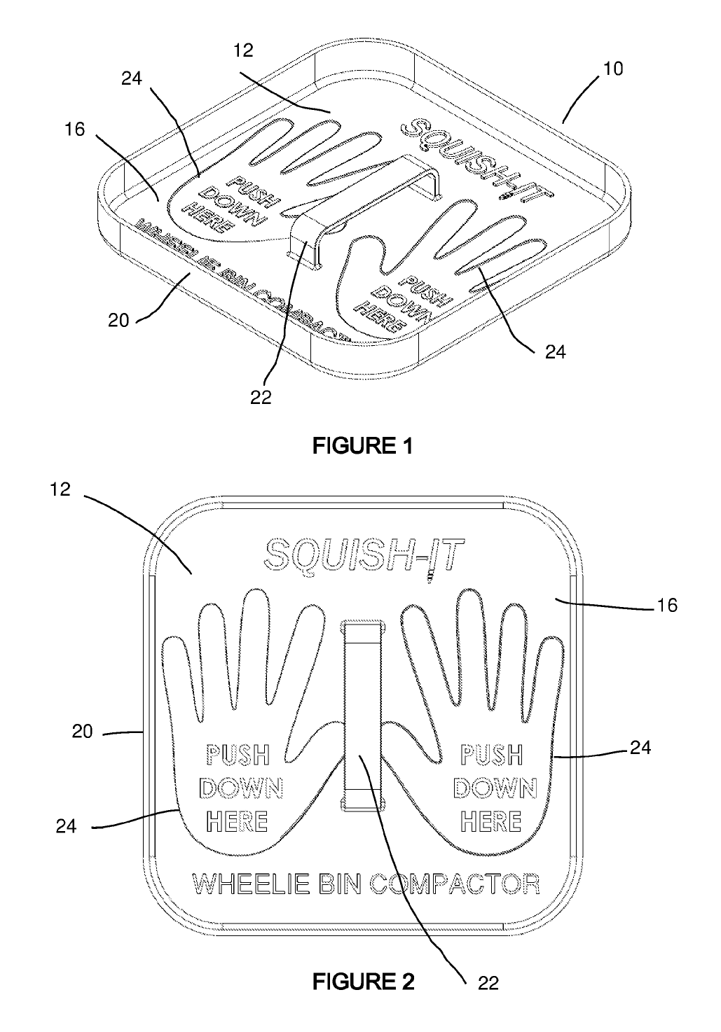

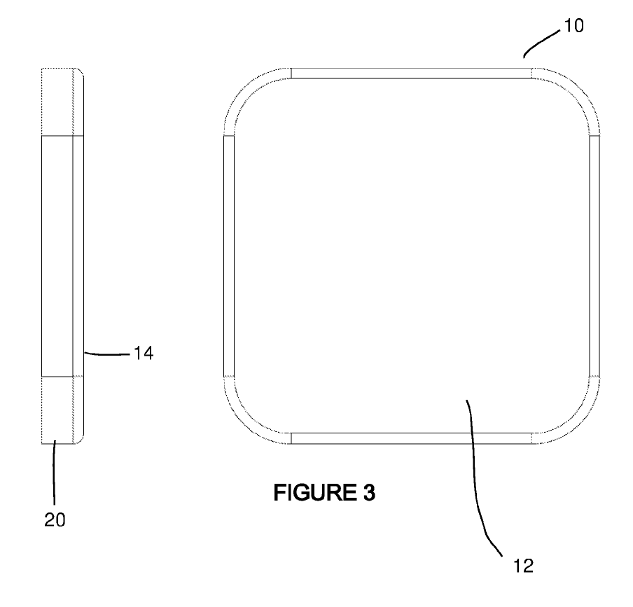

FIGS. 1 to 3 show a manual bin compacting plate 10 according to a preferred embodiment of the present invention. The compacting plate 10 comprises a flat rectangular body 12 with rounded corners. The body 12 has a bottom surface 14 and a top surface 16. A perimeter flange 20 extends upwardly from a perimeter edge of the body 12, generally forming a recessed space with the top surface 16.

The top surface 16 comprises a handle 22 at a central portion thereof, and left and right hand print outlines 24 at each side of the handle 22. The hand print outlines 24 both include the writing “PUSH DOWN HERE”, and the top surface 16 includes the product trade mark “SQUISH-IT” and description “WHEELIE BIN COMPACTOR”.

The compacting plate 10 in the embodiment has a length and width of 360 mm. The perimeter flange 20 is 5 mm thick and 40 mm in height from the bottom surface 14.

The compacting plate 10 is made from rigid metal, and in the preferred embodiment is made from coated metal. Alternatively, the compacting plate 10 can be made from rigid plastics material.

In use, the compacting plate 10 is used to compress garbage in a garbage bin, in particular the household wheelie bin. Typically, users would try to force down garbage which would not fit or overflow from a bin with their bare hands to compact and push the rubbish down. The user would aim to push the rubbish down enough so that the lid would close and prevent any rubbish spilling onto the street. Spilling of rubbish due to overfull wheelie bins causes environmental issues and garbage trucks also refuse to empty overflowing wheelie bins. Squashing garbage with bare hands however leads to many possible negative outcomes, such as damage to garbage bags thus spilling garbage out and allowing foul odours to escape, and sharp rubbish material (e.g. aluminium cans and broken glass) bursting through the garbage bag and causing injury to the user.

The compacting plate 10 is used by a user to safely compact garbage in a bin. The user would place the compacting plate 10 on top of garbage in a bin, place their hands on the hand print outlines 24 and apply their weight to the compacting plate 10 to compress the garbage in the bin. The rigid body of the compacting plate 10 and the perimeter flange 20 protects the user's hands such that any sharp or dirty objects in the garbage will not contact the user's hands.

The present invention therefore provides a manual hand compactor for use by household residents, schools, childcare centres, local businesses and the like, to squash down rubbish safely into wheelie bins. The compacting plate 10 can be made in different sizes to fit different size bins as needed.

The present invention provides a safe and effective way to reduce cuts, injuries, infections and disease transmission associated with the handling of hard waste.

The present invention can also effectively prevent rubbish overflow onto streets and nature strips. Rubbish accumulation on streets and nature strips presents health, environmental and occupational health and safety issues.

The present invention can further assist shire councils in keeping areas free of rubbish overflow.

Further, the present invention can assist children to learn and practice safely compacting rubbish in school wheelie bins.

Whilst preferred embodiments of the present invention have been described, those skilled in the art will recognise that modifications can be made to these embodiments.

For example, the compacting plate 10 can include two side by side handles, instead of, or in addition to, the hand print outlines.

The perimeter flange 20 can also be of a higher height for more protection. The compacting plate 10 can also include a resilient sealing strip, for example a rubber strip, extending around the outer surface of the perimeter flange 20 or the body 12. The sealing strip can engage inside walls of the bin in use to substantially prevent material from flowing through a gap between the compacting plate 10 and the inside walls of the bin. The perimeter flange 20 can also be angled outwardly and upwardly, and may include a sealing strip at its top edge.

Alternatively, the perimeter flange 20 can be replaced by a resilient flange (such as a rubber flange). Such a resilient flange can initially extend outwardly, at which it will engage the inside walls of the bin in use and then curve upwardly during the compacting step. Such a resilient flange will thus perform two functions, being sealing against the inside walls of the bin and protecting the user's hands.

The compacting plate 10 can also include a hook or other suitable attachment means to hang the compacting plate 10 to the handle of the bin, or any other part of the bin when not in use. This will allow the compacting plate 10 to be easily locatable when needed. In one embodiment a hook may be attached to the perimeter flange 20.

Alternatively, the compacting plate 10 can include one or more elastic straps to attach the compacting plate 10 to the lid of a wheelie bin. The compacting plate 10 can be positioned on top or on the bottom (inside) surface of the lid. This will allow the compacting plate 10 to be easily locatable, as well as the user being able to leave the compacting plate 10 on the lid even when garbage trucks empty the wheelie bin.

For use with larger bins, the compacting plate 10 can include means for connection to a larger expanded plate body, to increase the width and length of the compacting plate 10 if needed.

The body of the compacting plate 10 can also be curved, such as a bowl shape or an inverted bowl shape for the bottom surface 14. These embodiments will provide their own advantages, such as the inverted bowl shape compacting items along the edges first.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The terms “a” and “an” are used herein to refer to one or to more than one (i.e. to at least one) of the grammatical object of the article. By way of example, “an element” means one element or more than one element.

1. A bin compacting plate comprising a compacting body sized to fit within a bin.

2. The compacting plate of claim 1, wherein the body is generally rigid and flat, and having a bottom surface and a top surface.

3. The compacting plate of claim 1, wherein the body comprises a perimeter flange extending generally upwardly from a perimeter edge of the body.

4. The compacting plate of claim 2, wherein the top surface comprises at least one handle.

5. The compacting plate of claim 2, wherein the top surface comprises left and right hand print outlines.

6. The compacting plate of claim 5, wherein the hand print outlines comprise the writing “PUSH DOWN HERE”.

7. The compacting plate of claim 1, wherein the compacting plate is made from rigid metal or a plastic material.

8. The compacting plate of claim 1, wherein the compacting plate comprises two side by side handles.

9. The compacting plate of claim 1, wherein the compacting plate includes a resilient sealing strip extending around the perimeter thereof.

10. The compacting plate of claim 1, wherein the compacting plate includes a resilient flange extending outwardly from a perimeter edge thereof.

11. The compacting plate of claim 1, wherein the compacting plate includes an attachment means to hang the compacting plate to a handle of a bin when not in use.

12. The compacting plate of claim 1, wherein the compacting plate includes one or more elastic straps to attach the compacting plate to the lid of a bin.

13. The compacting plate of claim 1, wherein the compacting plate includes means for connection to a larger expander plate body to increase the width and length of the compacting plate.

14. The compacting plate of claim 13, further comprising an expander plate body for attachment thereto.

15. The compacting plate of claim 2, wherein the bottom surface curved.

16. The compacting plate of claim 15, wherein the bottom surface is bowl shaped inverted bowl shaped.
